(19) United States
(12) Patent Application Publication
(10) Pub. No.: US 2003/0021526 A1
(43) Pub. Date: Jan. 30, 2003

(54) Dynamic dispersion compensator

(76) Inventor: Oleg Bouevitch, Gloucester (CA)

Correspondence Address: JDS Uniphase Corporation, 3000 Merivale Road, Ottawa, ON, K2G 6N7, CA

(21) Appl. No.: 10/252,597

(22) Filed: Sep. 24, 2002

Related U.S. Application Data
(63) Continuation-in-part of application No. 09/729,270, filed on Dec. 5, 2000.
(60) Provisional application No. 60/326,844, filed on Oct. 4, 2001.

(51) Int. Cl. G02B 6/293; G02B 6/26

(52) U.S. Cl. 385/24; 385/15

(57) ABSTRACT

A modular optical platform for selective wavelength switching that can be adapted to perform various other functions, such as dispersion compensation, dynamic gain equalization (DGE) and add/drop multiplexing (ADM) provides the versatility and modularity that will be essential to the future of the fiber optics industry. The basic platform includes a first lens for directing an optical signal, a diffraction grating for dispersing an optical signal into its component wavelength channels, a second lens for directing the component wavelength channels, and a modifying device for conducting one or more of a variety of functions including dispersion compensation, switching, DGE and COADM. The first and second lens are preferably replaced by a single concave reflective mirror having optical power. The modifying means for dispersion compensation according to the present invention includes a tunable etalon.

### CROSS-REFERENCE TO RELATED APPLICATIONS

This application is a continuation-in-part of U.S. patent application No. 09/729,270 filed May 12, 2000 and claiming priority from Provisional Appl. No. 60/326,844 filed on Oct. 4, 2001.

### TECHNICAL FIELD

The present application relates to a wavelength selective optical platform, and in particular to a wavelength selective optical device with dynamically-tunable dispersion compensation.

### BACKGROUND OF THE INVENTION

In high bit rate light-wave systems, tunable chromatic dispersion compensators are required to compensate for the various dispersions accumulated along the different paths taken by each of the individual signal channels.

Known dispersion compensation techniques include dispersion compensation fibers, chirped Bragg grating, and cascaded Mach-Zehnder filters. Devices for dispersion compensation are known. U.S. Pat. No. 5,283,845 granted to J. W. Ip on Feb. 1, 1994 discloses a multi-port tunable fiber-optic filter. U.S. Pat. No. 6,141,130 granted to J. W. Ip on Oct. 31, 2000 discloses an amplitude-wavelength equalizer for a group of wavelength division multiplexed channels. U.S. Pat. No. 5,557,468 granted to J. W. Ip on Sep. 17, 1996 discloses a chromatic dispersion compensation device.

A recent approach for dispersion compensation utilizes Gires-Tournois Interferometers (GTI), which potentially provide low-loss and polarization insensitivity, while offering high negative dispersion without exhibiting the nonlinear behavior found in fiber-based dispersion compensating devices. Moreover, GTI's can be made to be colorless for compensating multi-channel dispersion in a very compact device. U.S. Pat. No. 6,081,379 granted to R. R. Austin et al. discloses a monolithic multiple GTI device providing negative group delay dispersion. A GTI is basically an asymmetric Fabry-Perot etalon, providing a constant amplitude response over all frequencies and a phase response that varies with frequency. The key to using a GTI for dispersion compensation is that each frequency component of the signal remains trapped in the interferometer for a longer time as the frequency approaches the interferometer's resonant frequency. Therefore, negative or positive delays depend on the position of the signal spectrum with respect to the resonance peak, and the closer the signal frequency component is to the cavity resonance the greater the delay.

A paper by C. K. Madsen, entitled “Tunable Dispersion Compensating MEMS All-Pass Filter”, IEEE Photonics Technology Letters, Vol. 12; No. 6, June 2000, which is incorporated herein by reference, discloses a tunable dispersion compensation technique with a microelectromechanical (MEM) actuated variable reflector and a thermally tuned cavity.

U.S. Pat. No. 6,289,151 granted to Kazrinov et al. discloses an all-pass optical filter for reducing the dispersion of optical pulses by applying a desired phase response to optical pulses transmitted through the filter.

Typically, gain equalizing and add/drop multiplexer devices involve some form of multiplexing and demultiplexing to modify each individual channel of the telecommunication signal. In particular, it is common to provide a first diffraction grating for demultiplexing the optical signal and a second spatially separated diffraction grating for multiplexing the optical signal after it has been modified. An example of the latter is disclosed in U.S. Pat. No. 5,414,540, incorporated herein by reference. However, in such instances it is necessary to provide and accurately align two matching diffraction gratings and at least two matching lenses. This is a significant limitation of prior art devices.

To overcome this limitation, other prior art devices have opted to provide a single diffraction grating that is used to demultiplex an optical single in a first pass through the optics and multiplex the optical signal in a second pass through the optics. For example, U.S. Pat. Nos. 5,233,405; 5,526,155; 5,745,271; 5,936,752; and 5,960,133; which are incorporated herein by reference, disclose such devices.

However, none of these prior art devices disclose an optical arrangement suitable for dynamic gain equalizer (DGE), configurable optical add/drop multiplexer (COADM), and dispersion compensation applications. In particular, none of these prior art devices recognize the advantages of providing a simple, symmetrical optical arrangement suitable for use with a dynamic dispersion compensator.

For example, U.S. Pat. No. 5,414,540 to Patel et al. discloses a liquid crystal optical switch for switching an input optical signal to selected output channels. The switch includes a diffraction grating, a liquid crystal modulator, and a polarization dispersive element. In one embodiment, Patel et al. suggest extending the 1×2 switch to a 2×2 drop-add circuit and using a reflector. However, the disclosed device is limited in that the add/drop beams of light are angularly displaced relative to the input/output beams of light. This angular displacement is disadvantageous with respect to coupling the add/drop and/or input/output beams of light into parallel optical waveguides, in addition to the additional angular alignment required for the input beam of light.

With respect to compactness, prior art devices have been limited to an excessively long and linear configurations, wherein the input beam of light passes through each optical component sequentially before being reflected in a substantially backwards direction.

U.S. Pat. No. 6,081,331 discloses an optical device that uses a concave mirror for multiple reflections as an alternative to using two lenses or a double pass through one lens. However, the device disclosed therein only accommodates a single pass through the diffraction grating and does not realize the advantages of the instant invention.

An object of the present invention is to provide an optical configuration for rerouting and modifying an optical signal that can be used as a dynamic dispersion compensator.

### SUMMARY OF THE INVENTION

Accordingly, the present invention relates to an optical device comprising:

a first port for launching an input beam of light including a plurality of wavelength channels;

a second port for receiving an output beam including at least a portion of one of the plurality of wavelength channels;

first redirecting means for receiving the input beam of light, the first redirecting means having optical power;

a dispersive element for receiving the input beam of light from the first redirecting means, and for dispersing the input beam of light into the plurality of wavelength channels;

second redirecting means for receiving the dispersed wavelength channels, the second redirecting means having optical power; and

a plurality of modifying means, each modifying means for receiving a corresponding one of the dispersed wavelength channels from the second redirecting means, and for reflecting at least a portion of the corresponding wavelength channel back to the second redirecting means;

wherein each of said modifying means includes a tunable etalon for providing dispersion compensation to said corresponding wavelength channel; and

wherein at least one of the wavelength channels travel back via the second redirecting means to the dispersive element for recombination into the output beam, which is output the second port via the first redirecting means.

Another aspect of the present invention relates to a dispersion compensator comprising:

a first port for launching an input beam of light including a plurality of wavelength channels;

a second port for receiving an output beam including the plurality of wavelength channels;

first redirecting means for receiving the input beam of light, the first redirecting means having optical power;

a dispersive element for receiving the input beam of light from the first redirecting means, and for dispersing the input beam of light into the plurality of wavelength channels;

second redirecting means for receiving the dispersed wavelength channels, the second redirecting means having optical power; and

a plurality of tunable etalons, each tunable etalon for receiving a corresponding one of the dispersed wavelength channels from the second redirecting means, and for reflecting the corresponding wavelength channel back to the second redirecting means, each tunable etalon for providing dispersion compensation to said corresponding wavelength channel;

wherein the plurality of wavelength channels travel back via the second redirecting means to the dispersive element for recombination into the output beam, which is output the second port via the first redirecting means.

### BRIEF DESCRIPTION OF THE DRAWINGS

The invention will be described in greater detail with reference to the accompanying drawings which represent preferred embodiments thereof, wherein:

FIG. 1a is a schematic diagram illustrating an embodiment of an optical configuration that can be used as a dynamic gain equalizer (DGE), add-drop multiplexer (COADM) or a dynamic dispersion compensator in accordance with the invention;

FIG. 1b is a top view of the device of FIG. 1a modified to be a dynamic dispersion compensator;

FIG. 2a is a detailed side view of a front-end module for use with the optical configuration shown in FIG. 1 having means for compensating for polarization mode dispersion (PMD);

FIG. 2b is a detailed side view of an alternative front-end module having means for reducing or substantially eliminating PMD;

FIG. 3a is a top view of one embodiment of modifying means comprising a liquid crystal array for use with the DGE/COADM shown in FIG. 1, wherein a liquid crystal element is switched to an ON state;

FIG. 3b is a top view of the modifying means shown in FIG. 3a, wherein the liquid crystal element is switched to an OFF state;

FIG. 3c is a top view of another embodiment of the modifying means for use with the DGE/COADM shown in FIG. 1, wherein the liquid crystal element is switched to an ON state;

FIG. 3d is a top view of the modifying means shown in FIG. 3c, wherein the liquid crystal element is switched to an OFF state;

FIG. 4a is a top view of another embodiment of the modifying means for use with the DGE/COADM shown in FIG. 1 having a birefringent crystal positioned before the liquid crystal array, wherein the liquid crystal element is switched to an OFF state;

FIG. 4b is a top view of the modifying means shown in FIG. 4a, wherein the liquid crystal element is switched to an ON state;

FIG. 4c is a top view of yet another embodiment of the modifying means for use with the DGE shown in FIG. 1 utilizing a MEMS device;

FIG. 5a is a side view of another embodiment of the modifying means including a tunable etalon for use as a dynamic dispersion compensator;

FIG. 5b is a side view of schematically illustrates another example of a tunable etalon for use in a dynamic dispersion compensator;

FIGS. 6a and 6b are schematic diagrams of an embodiment of the invention that is preferred over the one shown in FIG. 1, wherein the focal plane of a single spherical reflector is used to locate the input/output ports, diffraction grating, and modifying means;

FIG. 7 is a schematic diagram of an embodiment of the invention that is similar to that shown in FIGS. 6a and 6b, wherein the input/output ports are disposed between the modifying means and dispersive element;

FIG. 8 is a schematic diagram of an optical platform having a configuration similar to that shown in FIGS. 6a and 6b including an optical circulator; and

FIG. 9 is a schematic diagram of an optical platform in accordance with the instant invention including a lens having a single port for launching and receiving light from the spherical reflector;

FIG. 9a is a top view showing a lens array coupling input/output optical waveguides to the lens in accordance with the instant invention;

FIG. 9b is a top view showing a prior art polarization diversity arrangement coupling input/output optical waveguides to the lens in accordance with the instant invention;

FIG. 9c is a side view of the prior art polarization diversity arrangement shown in FIG. 9b;

FIG. 9d is a top view showing an alternative arrangement to the optical components shown in FIG. 9b;

FIG. 9e is a side view of the alternate arrangement shown in FIG. 9d;

FIG. 9f is a top view showing an asymmetric offset of the input/output optical waveguides with respect to the optical axis of the lens, in accordance with the instant invention;

FIG. 10 is a schematic diagram of another embodiment of an optical platform arrangement in accordance with the invention;

FIG. 11 is a schematic diagram of the preferred embodiment of an optical platform with COADM functionality in accordance with the instant invention; and

FIG. 12 is a schematic diagram of an optical platform with COADM functionality in accordance with the instant invention, wherein an asymmetric arrangement of the input/output optical waveguides complements the angular displacement provided by a MEMS element.

### DETAILED DESCRIPTION

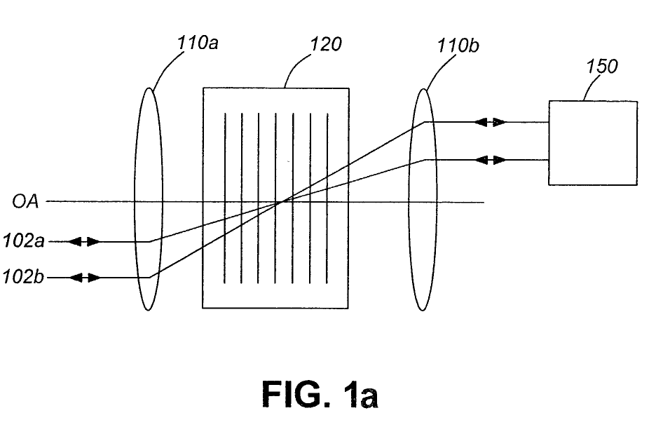

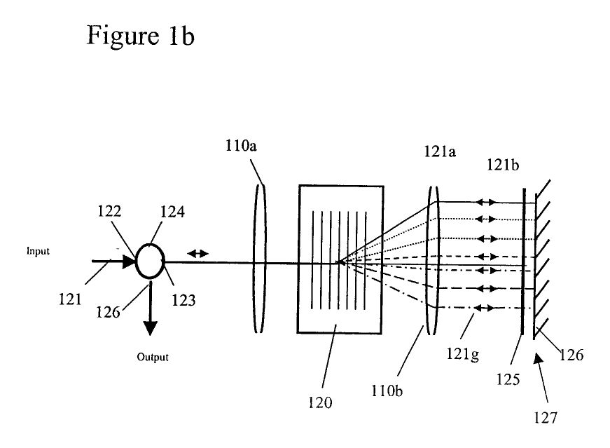

Referring now to FIG. 1a, an optical device for rerouting and modifying an optical signal in accordance with the instant invention is capable of operating as a Dynamic Gain/Channel Equalizer (DGE), a Configurable Optical Add/Drop Multiplexer (COADM), and/or a dynamic dispersion compensator.

The optical device of FIG. 1a includes a diffraction element 120 disposed between and at a focal plane of identical lens elements with optical power 110a and 110b. Two ports 102a and 102b are shown at an input/output end with bi-directional arrows indicating that light launched into port 102a can be transmitted through the optical device and can be reflected backward to the input port from which it was launched 102a, or alternatively, can be switched to port 102b or vice versa in a controlled manner. The input/output ports 102a and 102b are also disposed about one focal plane away from the lens element 110a to which they are optically coupled. Although only two input/output ports are shown to facilitate an understanding of this device, a plurality of such pairs of ports is optionally provided. At the other end of the device, a modifying means 150 is provided at the focal plane of the lens 110b for modifying at least a portion of the light incident thereon.

FIG. 1b illustrates the path taken by an input beam of light 121 as it passes through a first port 122 to a second port 123 of a circulator 124. The first lens 100a redirects the beam 121 at the diffraction grating 120, which disperses the beam of light into component sub-beams 121a to 121g. The second lens 110b redirects the sub-beams 121a to 121g towards the modifying means 150, which in this case is an array of dynamically tunable etalons with a partially reflective front surface 125, a fully reflective rear surface 126 and a cavity 127. The etalons are independently tunable to provide dispersion compensation for each individual sub-beam 121a to 121g. In this embodiment the sub-beams 121a to 121g are reflected directly back to the second lens 110b, which redirects the sub-beams back together for recombining by the diffraction grating 120. The recombined output beam of light is redirected by the first lens 110a to the second port 123 of the circulator 124, which subsequently directs the output beam out the third port 126.

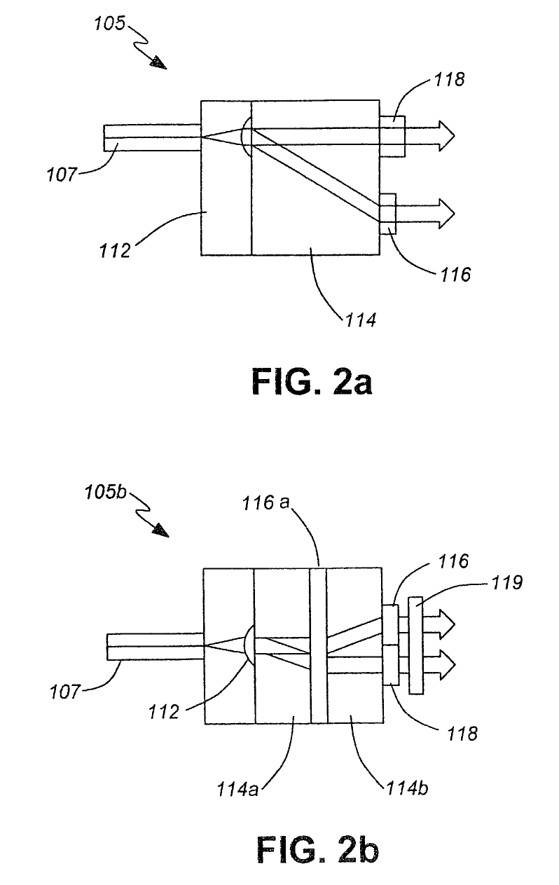

Since the modifying means and/or dispersive element are generally dependent upon polarization of the incident light beam, light having a known polarization state is provided to obtain the selected switching and/or attenuation. FIGS. 2a and 2b illustrate two different embodiments of polarization diversity arrangements for providing light having a known polarization state, for use with the dispersion compensators, DGE, and COADM devices described herein. The polarization diversity arrangement, which is optionally an array, is optically coupled to the input and output ports.

Referring to FIG. 2a, an embodiment of a front-end micro-optical component 105 for providing light having a known polarization includes a fibre tube 107, a micro-lens 112, and a birefringent crystal element 114 for separating an input beam into two orthogonally polarized sub-beams. At an output end, a half waveplate 116 is provided to rotate the polarization of one of the beams by 90° so as to ensure both beams have a same polarization state, e.g. horizontal. A glass plate or a second waveplate 118 is added to the fast axis path of the crystal 114 to lessen the effects of Polarization Mode Dispersion (PMD) induced by the difference in optical path length along the two diverging paths of crystal 114.

FIG. 2b illustrates an alternative embodiment to that of FIG. 2a, wherein two birefringent elements 114a, 114b have a half waveplate 116a disposed therebetween; here an alternate scheme is used to make the path lengths through the birefringent materials substantially similar. Optionally, a third waveplate 119 is provided for further rotating the polarization state.

Although, FIGS. 2a and 2b both illustrate a single input beam of light for ease of understanding, the front end unit 105 is capable of carrying many more beams of light therethrough, in accordance with the instant invention (i.e., can be designed as an array as described above).

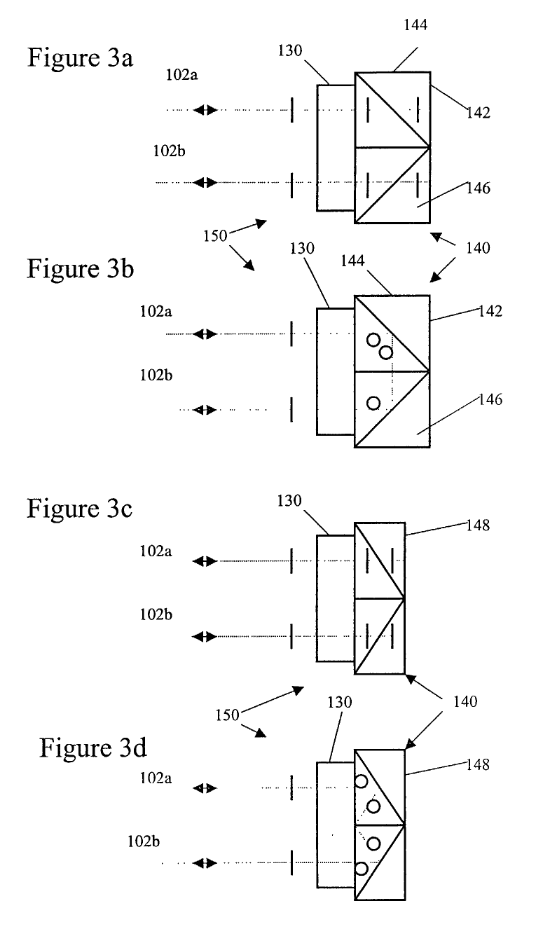

FIGS. 3a-3b, 3c-3d, 4a-4b, and 5, each illustrate a different embodiment of the modifying means for use with the DGE/COADM devices described herein. Each of these embodiments is described in more detail below. Note that the modifying means are generally discussed with reference to FIG. 1a. Although reference is made to the dispersive element 120 and the lens elements 110a and 110b, these optical components have been omitted from FIGS. 3a-3b, 3c-3d, 4a-4b, and 5 for clarity.

Referring to FIGS. 3a and 3b a schematic diagram of the modifying means 150 is shown including a liquid crystal array 130 and a reflector 140. The reflector includes first and second polarizing beam splitters 144 and 146, and a reflective surface 142.

When the device operates as a COADM, each pixel of the liquid crystal array 130 is switchable between a first state, e.g. an “ON” state shown in FIG. 3a, wherein the polarization of a beam of light passing therethrough is unchanged, e.g. remains vertical, and a second state, e.g. an “OFF” state shown in FIG. 3b, wherein the liquid crystal cell rotates the polarization of a beam of light passing therethrough 90°, e.g. is switched to horizontal. The reflector 140 is designed to pass light having a first polarization, e.g. vertical, such that a beam of light launched from the port 102a is reflected back to the same port, and designed to reflect light having another polarization, e.g. horizontal, such that a beam of light launched from the port 102a is switched to the port 102b.

When the device operates as a DGE, each liquid crystal cell is adjusted to provide phase retardations between 0° to 180°. For a beam of light launched and received from port 102a, 0% attenuation is achieved when liquid crystal cell provides no phase retardation, and 100% attenuation is achieved when the liquid crystal cell provides 180° phase retardation. Intermediate attenuation is achieved when the liquid crystal cells provide a phase retardation greater than 0° and less than 180°. In some DGE applications, the reflector 140 includes only a reflective surface 142, i.e. no beam splitter.

Preferably, the liquid crystal array 130 has at least one row of liquid crystal cells or pixels. For example, arrays comprising 64 or 128 independently controlled pixels have been found particularly practical, but more or fewer pixels are also possible. Preferably, the liquid crystal cells are of the twisted nematic type cells, since they typically have a very small residual birefringence in the “ON” state, and consequently allow a very high contrast ratio (>35 dB) to be obtained and maintained over the wavelength and temperature range of interest. It is possible that the inter-pixel areas of the liquid crystal array 130 are covered by a black grid.

FIGS. 3c and 3d are schematic diagrams analogous to FIGS. 3a and 3b illustrating an alternate form of the modifying means 150 discussed above, wherein the reflector 140 includes a double Glan prism 148. The arrangement shown in FIGS. 3c and 3d is preferred over that illustrated in FIGS. 3a and 3b, since the respective positions of the two-sub beams emerging from the polarization diversity arrangement (not shown) does not change upon switching.

Note that in FIGS. 3a-3d the dispersion direction is perpendicular to the plane of the paper. For exemplary purposes a single ray of light is shown passing through the modifying means 150.

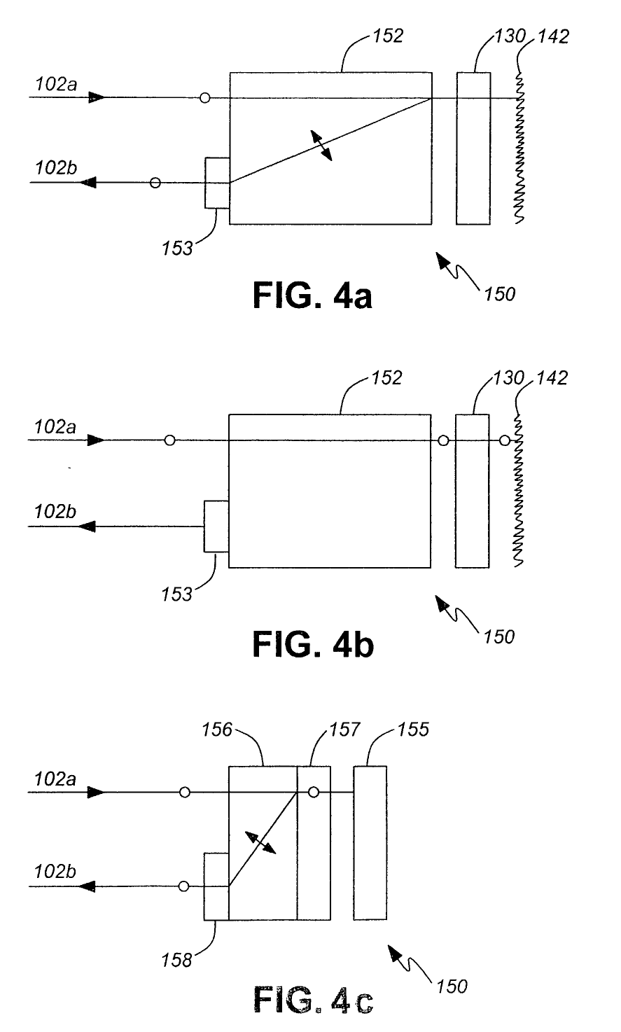

FIGS. 4a and 4b are schematic diagrams showing another embodiment of the modifying means 150, wherein a birefringent crystal 152 is disposed before the liquid crystal array 130. A beam of light having a predetermined polarization state launched from port 102a is dispersed into sub-beams, which are passed through the birefringent crystal 152. The sub-beams of light passing through the birefringent crystal 152 remain unchanged with respect to polarization. The sub-beams of light are transmitted through the liquid crystal array 130, where they are selectively modified, and reflected back to the birefringent crystal 152 via reflective surface 142. If a particular sub-beam of light passes through a liquid crystal cell in an “OFF” state, as shown in FIG. 4a, then the polarization thereof will be rotated by 90° and the sub-beam of light will be refracted as it propagates through the birefringent crystal 152 before being transmitted to port 102b. If the sub-beam of light passes through a liquid crystal cell in an “ON” state, as shown in FIG. 4b, then the polarization thereof will not be rotated and the sub-beam of light will be transmitted directly back to port 102a. A half wave plate 153 is provided to rotate the polarization of the refracted sub-beams of light by 90° to ensure that both reflected beams of light have a same polarization state.

FIG. 4c is a schematic diagram of another embodiment of the modifying means 150 including a micro electro-mechanical switch (MEMS) 155, which is particularly useful when the device is used as a DGE. A beam of light having a predetermined polarization state launched from port 102a is dispersed into sub-beams and is passed through a birefringent element 156 and quarter waveplate 157. The birefringent element 156 is arranged not to affect the polarization of the sub-beam of light. After passing through the quarter waveplate 157, the beam of light becomes circularly polarized and is incident on a predetermined reflector of the MEMS array 155. The reflector reflects the sub-beam of light incident thereon back to the quarter waveplate. The degree of attenuation is based on the degree of deflection provided by the reflector (i.e. the angle of reflection). After passing through the quarter waveplate 157 for a second time, the attenuated sub-beam of light will have a polarization state that has been rotated 90° from the original polarization state. As a result the attenuated sub-beam is refracted in the birefringent element 156 and is directed out of the device to port 102b. A half wave plate 158 is provided to rotate the polarization of the refracted sub-beams of light by 90°.

Of course, other modifying means 150 including at least one optical element capable of modifying a property of at least a portion of a beam of light and reflecting the modified beam of light back in substantially the same direction from which it originated are possible.

Advantageously, each of the modifying means discussed above utilizes an arrangement wherein each spatially dispersed beam of light is incident thereon and reflected therefrom at a 90° angle. The 90° angle is measured with respect to a plane encompassing the array of modifying elements (e.g. liquid crystal cells, MEMS reflectors). Accordingly, each sub-beam of light follows a first optical path to the modifying means where it is selectively switched such that it is reflected back along the same optical path, or alternatively, along a second optical path parallel to the first. The lateral displacement of the input and modified output beams of light (i.e., as opposed to angular displacement) allows for highly efficient coupling between a plurality of input/output waveguides. For example, the instant invention is particular useful when the input and output ports are located on a same multiple bore tube, ribbon, or block.

In order to maintain the desired simplicity and symmetry, it is preferred that the element having optical power be rotationally symmetric, for example a rotationally symmetric lens or spherical reflector. Moreover, it is preferred that the diffraction element 120 be a high efficiency, high dispersion diffraction grating. Optionally, a circulator (not shown) is optically coupled to each of ports 102a and 102b for separating input/output and/or add/drop signals.

Referring again to FIG. 1a, the operation of the optical device operating as a COADM is described by way of the following example. A collimated beam of light having a predetermined polarization and carrying wavelengths λ₁, λ₂, . . . λ₈ is launched through port 102a to a lower region of lens 110a and is redirected to the diffraction grating 120. The beam of light is spatially dispersed (i.e. de-multiplexed) according to wavelength in a direction perpendicular to the plane of the paper. The spatially dispersed beam of light is transmitted as 8 sub-beams of light corresponding to 8 different spectral channels having central wavelengths λ₁, λ₂, . . . λ₈ through lens 110b, where it is collimated and incident on the modifying means 150, which for exemplary purposes is shown in FIGS. 3a-3b. Each sub-beam of light is passed through an independently controlled pixel in the liquid crystal array 130. In particular, the sub-beam of light having central wavelength λ₃ passes through a liquid crystal cell in an “OFF” state, and each of the other 7 channels having central wavelengths λ₁-λ₂ and λ₄-λ₈ pass through liquid crystal cells in an “ON” state. As the sub-beam of light having central wavelength λ₃ passes through the liquid crystal in the “OFF” state, the polarization thereof is rotated 90°, it is reflected by the polarization beam splitter 144 towards a second beam splitter 146, and is reflected back to port 102b, as shown in FIG. 3b. As the other 7 channels having central wavelengths λ₁-λ₂ and λ₄-λ₈ pass through liquid crystal cells is in an “ON” state, the polarizations thereof remain unchanged, and they are transmitted through the polarization beam splitter 144 and are reflected off reflective surface 142 back to port 102a. In summary, the beam of light originally launched from port 102a will return thereto having dropped a channel (i.e. having central wavelength λ₃) and the sub-beam of light corresponding to the channel having central wavelength λ₃ will be switched to port 102b.

Simultaneously, a second beam of light having a predetermined polarization and carrying another optical signal having a central wavelength λ₃ is launched from port 102b to a lower region of lens 110a. It is reflected from the diffraction grating 120, and is transmitted through lens 110b, where it is collimated and incident on the modifying means 150. The second beam of light passes through the liquid crystal cell in the “OFF” state, the polarization thereof is rotated 90°, it is reflected by the second polarization beam splitter 146 towards the first beam splitter 144, and is reflected back to port 102a, as shown in FIG. 3b. Notably, the 7 express channels and the added channel are multiplexed when they return via the dispersion grating 120.

Since every spectral channel is passed through an independently controlled pixel before being reflected back along one of the two possible optical paths, a fully re-configurable switch for a plurality of channels is obtained.

Notably, the choice of eight channels is arbitrarily chosen for exemplary purposes. More or fewer channels are also within the scope of the instant invention.

Referring again to FIG. 1a, the operation of the optical device operating as a DGE is described by way of the following example. A collimated beam of light having a predetermined polarization and carrying channels λ₁, λ₂, . . . λ₈ is launched from port 102a through lens 110a, where it is redirected to diffraction grating 120. The beam of light is spatially dispersed according to wavelength in a direction perpendicular to the plane of the paper. The spatially dispersed beam of light is transmitted as 8 sub-beams of light corresponding to 8 different spectral channels having central wavelengths λ₁, λ₂, . . . λ₈ through lens 110b, where it is collimated and incident on the modifying means 150 such that each sub-beam of light is passed through an independently controlled pixel in the liquid crystal array 130 wherein the polarization of each sub-beam of light is selectively adjusted. In particular, the sub-beam of light having central wavelength λ₃ is passed through a liquid crystal cell in an “ON” state, the polarization thereof is not adjusted, it passes through the beam splitter 144, and is reflected back to port 102a with no attenuation, as illustrated in FIG. 3a. Simultaneously, a sub-beam of light having central wavelength λ₄ is passed through a liquid crystal cell in an “OFF” state, the polarization thereof is rotated by 90°, it is reflected from beam splitters 144 and 146 and is directed to port 102b. 100% attenuation is achieved with respect to this sub-beam of light returning to port 102a. Simultaneously, a sub-beam of light having central wavelength λ₅ is passed through a liquid crystal cell that provides phase retardation between 0° and 180°, it is partially transmitted through from beam splitter 144 and returns to port 102a an attenuated signal. The degree of attenuation is dependent upon the phase retardation.

Optionally, a second beam of light is simultaneously launched from port 102b into the optical device for appropriate attenuation. In fact, this optical arrangement provides a single optical system that is capable of providing simultaneous attenuation for a plurality of input ports (not shown).

Alternatively, the attenuated light is received from port 102b, hence obviating the need for a circulator. In this instance, when the polarization of a beam of light having central wavelength λ₃ is rotated by 90°, i.e. the liquid crystal array provides 180° phase retardation, it is reflected from the beam splitter 144 to the second beam splitter 146 (shown in FIG. 3a) and is directed to port 102b with no attenuation. Similarly, when the polarization of this beam of light is not adjusted, i.e. the liquid crystal array provides no phase retardation, it passes through the beam splitter 144 (shown in FIG. 3a) and is reflected back to port 102a. 100% attenuation with respect to this sub-beam of light reaching port 102b is achieved. Variable attenuation is achieved when the liquid crystal cell selectively provides phase retardation between 0° and 180°.

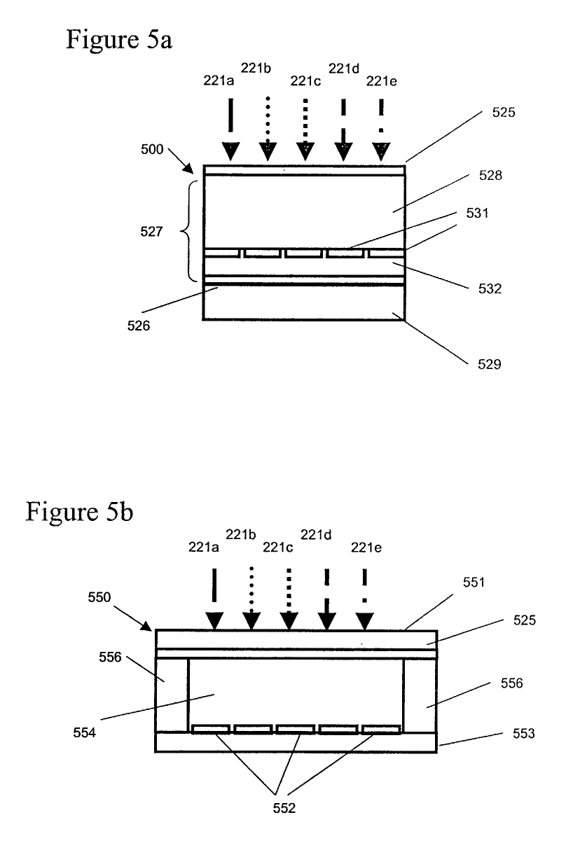

FIG. 5a illustrates a modifying means for dynamic dispersion compensation in the form of a tunable GT etalon 500 including a front partially reflective surface 525, and a rear fully reflective surface 526 defining a cavity 527 therebetween. The front surface 525 is comprised of a dielectric coating on a glass block 528. The rear surface 526 is coated onto a substrate 529. The cavity 527 is comprised of the glass block 528 with an array of transparent indium-tin oxide (ITO) electrodes 531 connected thereto adjacent a liquid crystal fluid 532. The liquid crystal axis of the fluid 532 is aligned with the polarization direction of the incoming light. Actuation of the individual electrodes 531 changes the index of refraction of the fluid 532 therebelow and thereby the optical path length of the cavity 527. Accordingly, each sub-beam 221a to 221g have a corresponding tunable etalon for individual dispersion compensation.

FIG. 5b illustrates an alternative arrangement for a tunable etalon 550 in which the front partially reflective surface 525 is in the form of a dielectric coating on a substrate 551, and the rear fully reflective coating is in the form of an array of piston MEMS mirrors 552 formed in a substrate 553. The cavity 527 is an air cavity 554 defined by spacers 556 constructed of low coefficient of thermal expansion (CTE) material, such as Invar®. In this case the cavity length of the individual tunable etalons is adjusted by physically moving the position of the back mirror, i.e. the piston mirror 552 to provide dispersion compensation to the individual sub-beams 221a to 221e. It is also possible to

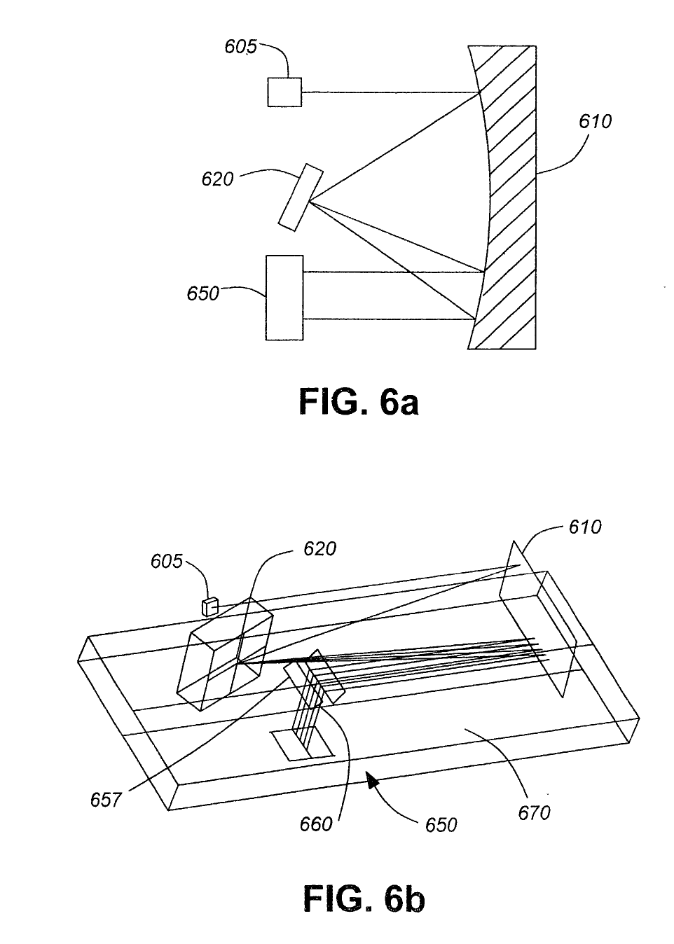

Turning now to FIG. 6a another embodiment of the optical platform for use as a dispersion compensator, a DGE and/or a COADM, which is preferred over the embodiment shown in FIG. 1, is shown. For clarity only one beam is shown exiting the front-end unit 605, however at least one other beam (not shown) can be disposed behind this beam.

In FIG. 6a a single element having optical power in the form of a spherical reflector 610 is used to receive a collimated beam of light from the front-end unit 605 and to receive and reflect beams of light to and from the diffraction grating 620 and the modifying means 650. The front-end unit 605, the diffraction grating 620, and the modifying means 650, are analogous to parts 105, 120, and 150 described above. However, in this embodiment the front-end unit 605, the diffraction grating 620, and the modifying means are each disposed about the single focal plane of the spherical reflector 610. Preferably, the diffraction grating is further disposed about the optical axis of the spherical reflector 610. In general, two circulators (not shown) are optically coupled to the front-end unit 605 to separate input/out and add/drop signals in ports 102a and 102b, as described above.

Preferably, the diffraction grating 620, the spherical reflector 610, and the modifying means 650 are each made of fused silica and mounted together with a beam folding mirror or prism 660 to a supporting plate 670 made of the same material or a material with a low coefficient of thermal expansion, e.g. Invar, as illustrated in FIG. 6b. The beam folding mirror or prism 660 is provided for space considerations. Advantageously, this design provides stability with respect to small temperature fluctuations. Moreover, this design is defocus free since the radius of curvature of the spherical reflector 610 changes in proportion to thermal expansion or contraction of any other linear dimensions. Advantageously, the spherical mirror 610 has substantially no chromatic aberrations.

When the optical device operates as a DGE, a detector array 657 is optionally positioned behind the beam-folding mirror 660 to intercept part of the wavelength dispersed beam of light. This design allows the signal to be tapped while eliminating the need for external feedback.

Preferably, the diffraction grating 620 and the modifying means 650 are disposed substantially one focal length away from the spherical mirror 610 or substantially at the focal plane of the spherical reflector 610, as discussed above. For example, in COADM applications it is preferred that the modifying means 650 are substantially at the focal plane to within 10% of the focal length. For DGE applications, it is preferred that the modifying means 650 are substantially at the focal plane to within 10% of the focal length if a higher spectral resolution is required, however, the same accuracy is not necessary for lower resolution applications.

In operation, a multiplexed beam of light is launched into the front-end unit 605. The polarization diversity arrangement 105 provides two substantially collimated sub-beams of light having the same polarization, e.g. horizontal, as discussed above. The two beams of light are transmitted to the spherical reflector 610 and are reflected therefrom towards the diffraction grating 620. The diffraction grating 620 separates each of the two sub-beams into a plurality of sub-beams of light having different central wavelengths. The plurality of sub-beams of light are transmitted to the spherical reflector 610 where they are collimated and transmitted to the modifying means 650 where they are incident thereon as spatially separated spots corresponding to individual spectral channels. Each sub-beam of light corresponding to an individual spectral channel is modified and reflected backwards either along the same optical path or another optical path according to its polarization state, as described above. The sub-beams of light are transmitted back to the spherical reflector 610 and are redirected to the dispersive element 620, where they are recombined and transmitted back to the spherical reflector 610 to be transmitted to the predetermined input/output port.

Optionally, second, third, forth, . . . etc. multiplexed beams of light are launched into the front-end unit 605. In fact, this optical arrangement is particularly useful for applications requiring the manipulation of two bands, e.g. C and L bands, simultaneously, wherein each band has its own corresponding in/out/add/drop ports.

Advantageously, the optical arrangement shown in FIGS. 6a and 6b provides a symmetrical 4-f optical system with fewer alignment problems and less loss than prior art systems. In fact, many of the advantages of this design versus a conventional 4f system using separate lenses is afforded due to the fact that the critical matching of components is obviated. One significant advantage relates to the fact that the angle of incidence on the grating, in the first and second pass, is inherently matched with the optical arrangement.

The instant invention further provides an optical device for rerouting and modifying an optical signal device that is substantially more compact and that uses substantially fewer components than similar prior art devices.

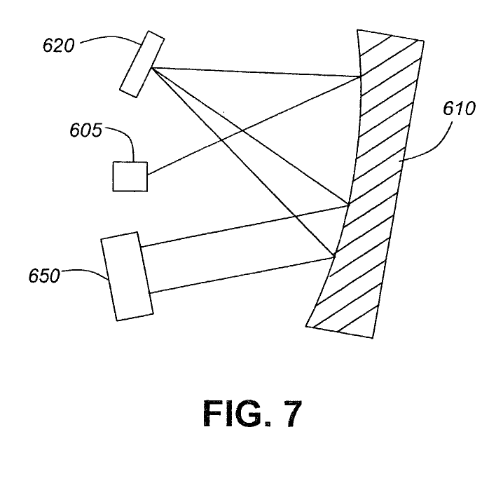

FIG. 7 shows an alternate arrangement of FIG. 6a and FIG. 6b that is particularly compact. In this embodiment, the more bulky dispersive element 620 and modifying means 650 are disposed outwardly from the narrower front-end unit 605.

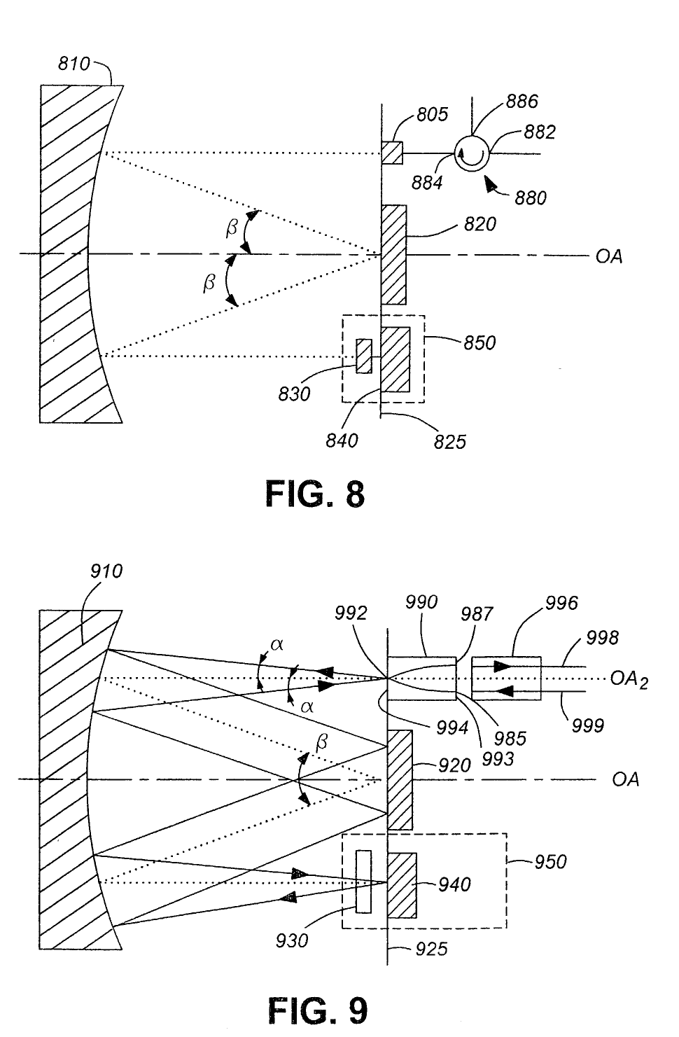

FIG. 8 illustrates an optical platform for use as a dispersion compensator or DGE including a conventional three port optical circulator 880 and having a particularly symmetrical design. A beam of light is launched into a first port 882 of the circulator 880 where it circulates to and exits through port 884. The beam of light exiting port 884 is passed through the front-end unit 805, which produces two collimated sub-beams having a same polarization that are transmitted to an upper region of the spherical reflector 810 in a direction parallel to an optical axis OA thereof. The collimated sub-beams of light incident on the spherical reflector 810 are reflected and redirected to the diffraction grating 820 with an angle of incidence β. The sub-beams of light are spatially dispersed according to wavelength and are transmitted to a lower region of the spherical reflector 810. The spatially dispersed sub-beams of light incident on the lower region of the spherical reflector 810 are reflected and transmitted to the modifying means 850 in a direction parallel to the optical axis of the spherical reflector 810. Once compensated or attenuated, the sub-beams of light are reflected back to the spherical reflector 810, the diffraction grating 820, and the front-end unit 805 along the same optical path. The diffraction grating recombines the spatially dispersed sub-beams of light. The front-end unit 805 recombines the two sub-beams of light into a single beam of light, which is transmitted to the circulator 880 where it is circulated to output port 860. The front-end unit 805, diffraction grating 820, and modifying means 850, which are similar to components 105, 120, and 150 described above, are each disposed about a focal plane 825 of the spherical reflector 810. In particular, the diffraction grating 820 is disposed about the focal point of the spherical reflector 810 and the modifying means 850 and front-end unit are symmetrically disposed about the diffraction grating. Preferably, the modifying means is a tunable etalon 850 including a front partially reflective surface 830 and a rear fully reflective surface 840.

Notably, an important aspect of the optical design described heretofore relates to the symmetry and placement of the optical components. In particular, the fact that each of the front-end unit, the element having optical power, the dispersive element, and the modifying means are disposed about one focal length (of the element having optical power) away from each other is particularly advantageous with respect to the approximately Gaussian nature of the incident beam of light.

Referring again to FIG. 8, the input beam of light emerges from the front-end unit 805 essentially collimated and is transmitted via the element having optical power 810 to the diffraction grating 820. Since the diffraction grating 820 is located at the focus of the element having optical power 810 and the input beams are collimated, the light is essentially focused on the diffraction grating 820, as discussed above. The 1/e² spot size at the grating, 2ω₁, and the 1/e² diameter 2ω₂ the front-end unit 805, are related by:

ω₁*ω₂=λ*f/π

where λ is wavelength and f is the focal length of the element having optical power. Accordingly, one skilled in the art can tune the spot size on the diffraction grating 820 and the resulting spectral resolution by changing the beam size at the front-end unit 805.

Moreover, the instant invention allows light beams launched from the front-end unit 805 to propagate to the liquid crystal array 830 with little or no spot expansion, since by symmetry, the spot size at the liquid crystal array is the same as the spot size at the front-end unit. Accordingly, the size of a beam of light launched from the front-end unit 805 can be changed to conform to the cell size of the liquid crystal array and/or vice versa. Alternatively, the size of the beam of light can be adjusted to change the spot size on the grating element 820, as discussed above. Obviously, the same tuning is achievable with the optical arrangements shown in both FIG. 1 and FIGS. 6a, 6b.

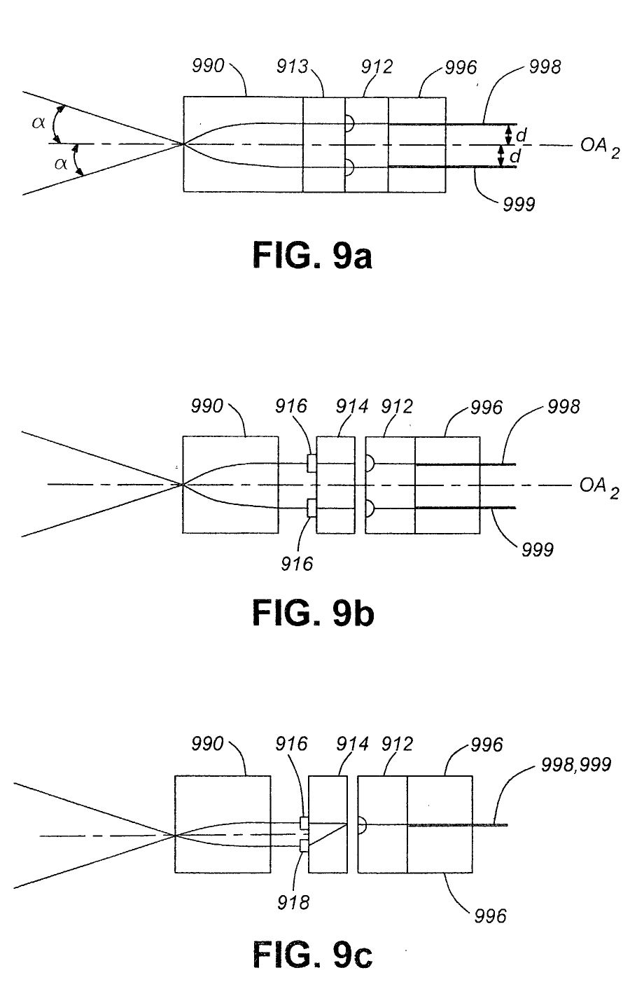

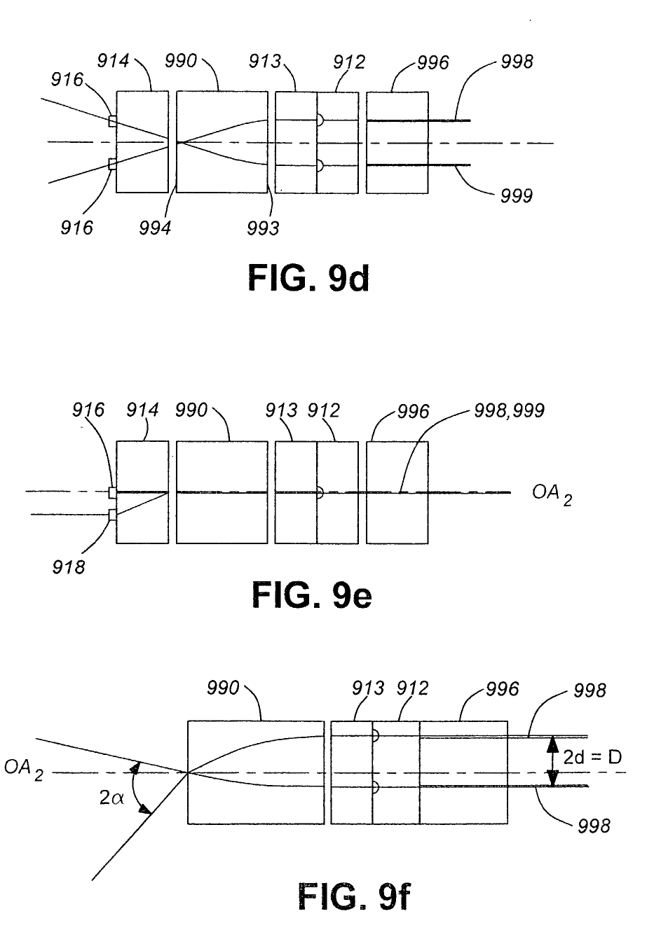

FIG. 9 illustrates an embodiment in accordance with the instant invention, wherein a single collimating/focusing lens 990 replaces the optical circulator 884 in the dispersion compensator or DGE shown in FIG. 8. Preferably, the lens 990 is a collimating/focusing lens such as a Graded Index or GRIN lens. The GRIN lens 990 is disposed such that an end face 994 thereof is coincident with the focal plane 925 of the spherical reflector 910. The GRIN lens 990 is orientated such that its optical axis (OA₂) is parallel to but not coaxial with the optical axis OA of the spherical reflector 990. An input 985 and an output 987 port are disposed about an opposite end face 993 of the lens 990, off the optical axis OA₂, and are optically coupled to input 999 and output 998 optical waveguides, respectively. Preferably, input 999 and output 998 waveguides are optical fibres supported by a double fibre tube, such as a double bore tube or a double v-groove tube. A single input/output port 992 is disposed about end face 994 coincident with the optical axis OA₂. The illustrated modifying means includes a tunable etalon 950 including a front partially reflective mirror 930 and a rear fully reflective mirror 940. Alternatively, the modifying means 950 could include a liquid crystal array 930 and a flat mirror 940 perpendicular to the OA of the spherical reflector 910. The modifying means may also comprise a pair of liquid crystal arrays, one in the incident path and one in the reflected path. Furthermore, a MEMS array (not shown) can replace the flat mirror 940 to enable individual channel control. All other optical components are similar to those described with reference to FIG. 8.

In operation, a beam of light is launched from input waveguide 999 into port 985 in a direction substantially parallel to the optical axis (OA₂) of the lens 990. The beam of light passes through the GRIN lens 990, and emerges from port 992 at an angle α to the optical axis. The angle α is dependent upon the displacement d of port 985 from the optical axis (OA₂). The beam of light is transmitted to an upper end of the spherical reflector 910, where it is directed to the diffraction grating 920 with an angle of incidence β. The resulting spatially dispersed beam of light is transmitted to the spherical reflector 910, is reflected, and is transmitted to the modifying means 950. If the diffraction grating 920 is parallel to the focal plane 925, as shown in FIG. 9, the beam of light incident on the modifying means has an angle of incidence substantially close to α. Each sub-beam of the spatially dispersed beam of light is selectively reflected back to the spherical reflector 910 at a predetermined angle, generally along a different optical path from which it came. Dispersion compensation or variable attenuation is provided by the modifying means 950. The spherical reflector 910 redirects the modified spatially dispersed beam of light back to the diffraction grating 920 such that it is recombined to form a single modified output beam of light, which is incident on the single port 992 with an angle of incidence close to −α. The output beam of light is passed through the lens 990, and is directed towards output port 987 where it is transmitted to output optical fibre 998.

Advantageously, this simple device, which allows light to enter and exit through two different ports disposed at one end of the device, is simple, compact, and easy to manufacture relative to prior art modifying and rerouting devices.

Moreover, the instant design obviates the need for a bulky and costly optical circulator, while simultaneously providing an additional degree of freedom to adjust the mode size, which in part defines the resolution of the device, i.e. can adjust the focal length of GRIN lens 990.

Preferably, light transmitted to and from the output 998 and input 999 optical waveguides is focused/collimated, e.g. through the use of micro-collimators, thermally expanded core fibers, or lens fibers. Optionally, a front-end unit, e.g. as shown in FIGS. 2a or 2b, which is in the form of an array, couples input/output waveguides 999/998 to end face 993. FIGS. 9a-9d illustrate various optical input arrangements, which for exemplary purposes are illustrated with the arrangement shown in FIG. 2a.

In FIG. 9a the input 999 and the output 998 optical fibers are coupled to the GRIN lens 990 via a lenslet array 912. A spacer 913 is provided in accordance with the preferred tele-centric configuration. This optical arrangement, which does not provide polarization diversity, is suitable for applications that do not involve polarization sensitive components.

FIGS. 9b and 9c depict top and side views of the embodiment where a front-end unit, i.e. as shown in FIG. 2a, couples the input/output waveguides 999/998 to the GRIN lens 990. More specifically, the front-end unit includes sleeve 996, lenslet array 912, birefringent element 914, half waveplates 916, glass plates or second waveplates 918, and GRIN lens 990.

In FIGS. 9d and 9e there is shown top and side views of an arrangement wherein the birefringent element 914, half waveplates 916, and glass plates 918, which provide the polarization diversity, are disposed about end face 994 of GRIN lens 990 and a spacer 913 the lenslet array 912 are disposed about end face 993.

FIG. 9f illustrates an embodiment wherein the input 999 and output 998 optical waveguides are not symmetrically disposed about the optical axis OA₂ of the GRIN lens 990. In these instances, it is more convenient to compare the fixed distance between the input 999 and output 998 waveguides (D=2d) to the total angle between the input and output optical paths (2α). More specifically, the relationship is given approximately as:

$$\frac{D}{F} = 2 α$$

where F is the focal length of the GRIN lens 990.

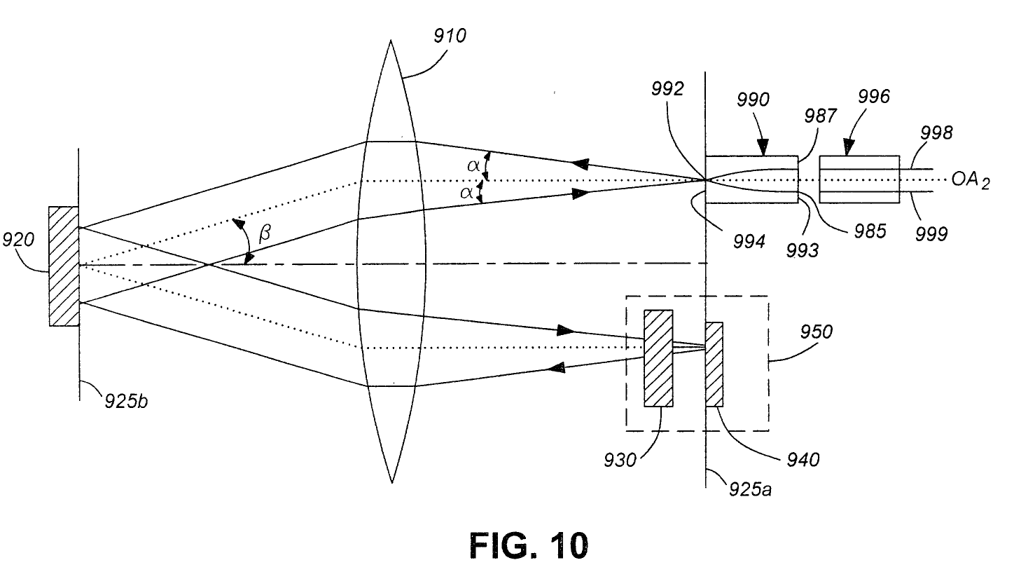

Of course other variations in the optical arrangement are possible. For example, in some instances, it is preferred that the diffraction grating 920 is disposed at an angle to the focal plane 925. In addition, the placement of the front end unit/lens 990, diffraction grating 920, and modifying means 950 can be selected to minimize aberrations associated with the periphery of the element having optical power 910. In FIG. 10, an alternative design of FIG. 9, wherein the element having optical power is a lens 910 having two focal planes, 925a and 925b is illustrated. The diffraction grating 920 is coincident with focal plane 925b and the reflector 940 is coincident with focal plane 925a. The operation is similar to that discussed for FIG. 9.

An advantage of the embodiments including a GRIN lens 990, e.g. as shown in FIG. 9-9d, is that they are compatible with modifying means based on MEMS technology, for both COADM and DGE applications. This is in contrast to the prior art optical arrangements described in FIGS. 1 and 6-8, wherein the MEMS based modifying means 150 are preferred for DGE applications over COADM applications.

In particular, when the single collimating/focusing lens 990 provides the input beam of light and receives the modified output beam of light, the angular displacement provided by each MEMS reflector complements the angular displacement resulting from the use of the off-axis input/output port(s) on the GRIN lens 990. More specifically, the angular displacement provided by the lens 990, e.g. α, is chosen in dependence upon the angular displacement of the MEMS device, e.g. 1°.

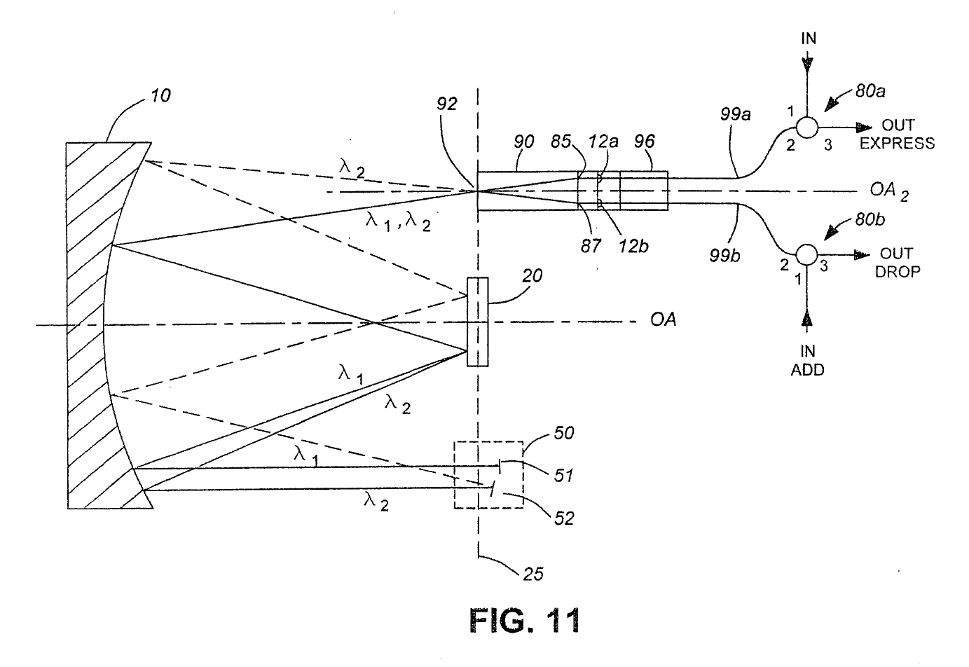

A preferred embodiment is illustrated in FIG. 11, wherein an arrangement similar to that shown in FIG. 9 designed to include COADM functionality. Optical circulators 80a and 80b are coupled to each of the optical waveguides 99a and 99b, respectively, for separating in/out and add/drop optical signals. Optical waveguides 99a and 99b are optically coupled to micro-lenses 12a and 12b disposed on one side of the lens 90.

The lens 90 is disposed such that an end thereof lies in the focal plane 25 of the spherical reflector 10. Also in the focal plane are the dispersive element 20 and the modifying means 50, as described above. However, in this embodiment, the modifying means is preferably a MEMS array 50. Notably, the MEMS array provides a 2×2 bypass configuration wherein an express signal launched into port 1 of the circulator 80a propagates to port 3 of the same circulator 80a in a first mode of operation and a dropped signal propagates to port 3 of the second circulator 80b in a second mode of operation. Similarly, a signal added at port 1 of the second circulator device 80b propagates to port 3 of the first circulator 80a in the second mode of operation, but is not collected in the first mode of operation. For exemplary purposes, the beam of light is assumed to include wavelengths λ₁ and λ₂, however, in practice more wavelengths are typically used.

In operation, a beam of light carrying wavelengths λ₁ and λ₂, is launched into port 1 of the first optical circulator 80a and is circulated to optical waveguide 99a supported by sleeve 96. The beam of light is transmitted through the micro-lens 12a to the lens 90, in a direction substantially parallel to the optical axis (OA₂) of the lens 90. The beam of light enters the lens 90 through port 85 disposed off the optical axis (OA₂) and emerges from port 92 coincident with the optical axis (OA₂) at an angle to the optical axis (OA₂). The emerging beam of light λ₁λ₂, is transmitted to an upper portion of the spherical reflector 10, is reflected, and is incident on the diffraction grating 20, where it is spatially dispersed into two sub-beams of light carrying wavelengths λ₁ and λ₂, respectively. Each sub-beam of light is transmitted to a lower portion of the spherical reflector 10, is reflected, and is transmitted to separate reflectors 51 and 52 of the MEMS array 50. Referring to FIG. 11, reflector 51 is orientated such that the sub-beam of light corresponding to λ₁ incident thereon, is reflected back along the same optical path to the lens 90, passes through port 85 again, and propagates to port 2 of circulator 80a where it is circulated to port 3. Reflector 52, however, is orientated such that the sub-beam of light corresponding to λ₂ is reflected back along a different optical path. Accordingly, the dropped signal corresponding to wavelength λ₂ is returned to the lens 90, passes through port 87, propagates to port 2 of the second circulator 80b, and is circulated to port 3.

Simultaneously, a second beam of light having central wavelength λ₂ is added into port 1 of the second optical circulator 80b and is circulated to optical waveguide 99b. The second beam of light λ₂ is transmitted through the micro-lens 12b to the lens 90, in a direction substantially parallel to the optical axis (OA₂) of the lens 90. It enters the lens 90 through port 87 disposed off the optical axis (OA₂) and emerges from port 92 coincident with the optical axis (OA₂) at an angle to the optical axis. The emerging beam of light is transmitted to an upper portion of the spherical reflector 10, is reflected, and is incident on the diffraction grating 20, where it is reflected to reflector 52 of the MEMS array 50. Reflector 52 is orientated such that the second beam of light corresponding to λ₂ is reflected back along a different optical path to the spherical reflector 10, where it is directed to the diffraction grating 20. At the diffraction grating 20, the added optical signal corresponding to λ₂ is combined with the express signal corresponding to λ₁. The multiplexed signal is returned to the lens 90, passes through port 85, and returns to port 2 of the first circulator 80a where it is circulated out of the device from port 3.

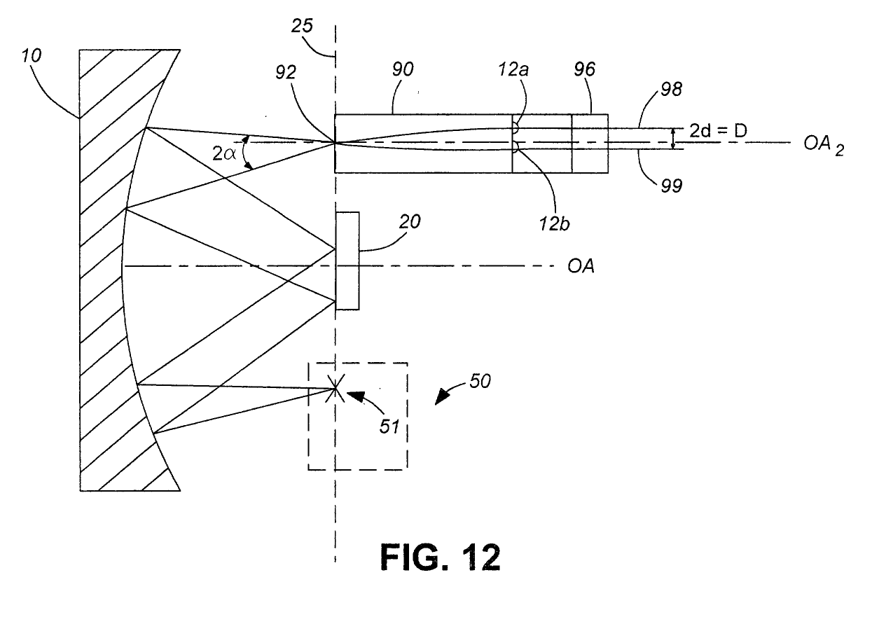

Of course, numerous other embodiments may be envisaged, without departing from the spirit and scope of the invention. For example, in practice it is preferred that each reflector of the MEMS array is deflected between positions non-parallel to focal plane 25, i.e. the deflection is not equivalent to the 45° and 0° deflections illustrated heretofore. In these instances, it is preferred that the optical waveguides coupled to the lens 90 be asymmetrically disposed about the optical axis OA₂, as illustrated in FIG. 9d. For example, FIG. 12 illustrates how strategic placement of the optical waveguides 99 and 98 can complement the angular displacement provided by the MEMS reflector 51. Moreover, it is also within the scope of the instant invention for the MEMS array to flip in either a horizontal or vertical direction, relative to the dispersion plane. Furthermore, any combination of the above embodiments and/or components are possible, such as a dispersion compensator/COADM combination in which an array of MEMS reflectors redirect individual sub-beams during or after passage through a tunable etalon. Similarly, a dispersion compensator/DGE combination is also possible.

We claim:

1. An optical device comprising:
a first port for launching an input beam of light including a plurality of wavelength channels;
a second port for receiving an output beam including at least a portion of one of the plurality of wavelength channels;
first redirecting means for receiving the input beam of light, the first redirecting means having optical power;
a dispersive element for receiving the input beam of light from the first redirecting means, and for dispersing the input beam of light into the plurality of wavelength channels;
second redirecting means for receiving the dispersed wavelength channels, the second redirecting means having optical power; and
a plurality of modifying means, each modifying means for receiving a corresponding one of the dispersed wavelength channels from the second redirecting means, and for reflecting at least a portion of the corresponding wavelength channel back to the second redirecting means;
wherein each of said modifying means includes a tunable etalon for providing dispersion compensation to said corresponding wavelength channel; and
wherein at least one of the wavelength channels travel back via the second redirecting means to the dispersive element for recombination into the output beam, which is output the second port via the first redirecting means.

2. The optical device according to claim 1, wherein each tunable etalon includes: a front partially reflective surface; a rear substantially fully reflective surface; an interferometric cavity, including a material with a variable index of refraction, therebetween; and a refractive index adjustor for altering the index of refraction of the material with a variable index of refraction.

3. The optical device according to claim 2, wherein the interferometric cavity includes liquid crystal fluid; and wherein the refractive index adjustor includes an electrode for altering the index of refraction of the liquid crystal fluid.

4. The optical device according to claim 1, wherein each tunable etalon includes: a front partially reflective surface; a rear substantially fully reflective surface; an interferometric cavity; and a mirror position adjustor for altering the relative positions of the front and rear surfaces.

5. The optical device according to claim 4, wherein the mirror position adjustor includes a piston MEMs device supporting the rear reflective surface for moving the rear reflective surface closer to and away from the front reflective surface.

6. The optical device according to claim 1, wherein each of the first and second redirecting means comprises a lens.

7. The optical device according to claim 1, wherein the first and second redirecting means comprise a same lens.

8. The optical device according to claim 7, wherein the dispersive element is disposed about one focal length away from on one side of the lens; and wherein the modifying means is disposed about one focal length away from the other side of the lens.

9. The optical device according to claim 1, wherein the first redirecting means and the second redirecting means comprise a single concave mirror.

10. The optical device according to claim 9, wherein the dispersive element and the modifying means are disposed one focal length away from the same side of the concave mirror.

11. The optical device according to claim 1, further comprising a circulator for directing the input beam of light from the first port to the first redirecting means, and for directing the output beam of light from the first redirecting means to the second port.

12. The optical device according to claim 1, further comprising a collimating/focusing lens having an optical axis, one side of the collimating/focusing lens including the first and second ports positioned off the optical axis, and the other side of the collimating/focusing lens including an input/output port coincident with the optical axis for launching the input beam at a first angle, and for receiving the output beam at a second angle.

13. The optical device according to claim 1, further comprising
a collimating/focusing lens for collimating light entering the device, and for focusing light exiting the device;
a polarization beam splitter optically coupled to the collimating/focusing lens for splitting light entering the device into two orthogonally polarized sub-beams, and for combining two orthogonally polarized sub-beams of light exiting the device; and
a polarization rotator for rotating the polarization of at least one of the two orthogonally polarized sub-beams entering the device, whereby both sub-beams have a first polarization, and for rotating the polarization of at least one of the two sub-beams of light exiting the device with the first polarization, whereby both sub-beams have orthogonal polarizations.

14. The optical device according to claim 1, wherein the modifying means further comprises a MEMS mirror array for directing selected wavelength channels back along a first set of paths for recombination into an express beam and output a third port, and for directing other wavelength channels along a second set of paths for recombination into the output beam for output the second port.

15. The optical device according to claim 14, further comprising:
a collimating/focusing lens having an optical axis, one side of the collimating/focusing lens including first and second input/output ports disposed off the optical axis, another side of the collimating/focusing lens including a third input/output port disposed coincident with the optical axis, the third input/output port for launching the input beam and receiving the express beam at a first angle, and for receiving the output beam at a second angle; and
a first circulator for directing the input signal from the first port to the first input/output port, and for directing the express beam to the third port;
wherein the second input/output port is optically coupled to the second port.

16. The optical device according to claim 14, further comprising:
a fourth port for launching an add signal including channels for addition to the express beam;
a collimating/focusing lens having an optical axis, one side of the collimating/focusing lens including first and second input/output ports disposed off the optical axis, another side of the collimating/focusing lens including a third input/output port disposed coincident with the optical axis, the third input/output port for launching the input beam and receiving the express beam at a first angle, and for launching the add signal and for receiving the output beam at a second angle;
a first circulator for directing the input signal from the first port to the first input/output port, and for directing the express beam from the first input/output port to the third port; and
a second circulator for directing the add signal from the fourth port to the second input/output port, and for directing the output beam from the second input/output port to the second port;
whereby the channels in the add signal are combined into the express beam by the dispersive element.

17. The optical device according to claim 1, wherein the dispersive element is a diffraction grating.

18. A dispersion compensator comprising:
a first port for launching an input beam of light including a plurality of wavelength channels;
a second port for receiving an output beam including the plurality of wavelength channels;
first redirecting means for receiving the input beam of light, the first redirecting means having optical power;
a dispersive element for receiving the input beam of light from the first redirecting means, and for dispersing the input beam of light into the plurality of wavelength channels;
second redirecting means for receiving the dispersed wavelength channels, the second redirecting means having optical power; and
a plurality of tunable etalons, each tunable etalon for receiving a corresponding one of the dispersed wavelength channels from the second redirecting means, and for reflecting the corresponding wavelength channel back to the second redirecting means, each tunable etalon for providing dispersion compensation to said corresponding wavelength channel;
wherein the plurality of wavelength channels travel back via the second redirecting means to the dispersive element for recombination into the output beam, which is output the second port via the first redirecting means.

19. The optical device according to claim 18, wherein the first redirecting means and the second redirecting means comprise a single concave mirror.

20. The optical device according to claim 18, wherein each tunable etalon includes: a front partially reflective surface; a rear substantially fully reflective surface; an interferometric cavity, including a material with a variable index of refraction, therebetween; and a refractive index adjustor for altering the index of refraction of the material with a variable index of refraction.
